(19) United States
(12) Patent Application Publication
(10) Pub. No.: US 2013/0346904 A1
(43) Pub. Date: Dec. 26, 2013

(54) TARGETED KEY PRESS ZONES ON AN INTERACTIVE DISPLAY

(71) Applicants: Lydia M. Do, Raleigh, NC (US); Michael J. Fork, Gibsonburg, OH (US); Kevin G. Paterson, San Antonio, TX (US)

(72) Inventors: Lydia M. Do, Raleigh, NC (US); Michael J. Fork, Gibsonburg, OH (US); Kevin G. Paterson, San Antonio, TX (US)

(73) Assignee: International Business Machines Corporation, Armonk, NY (US)

(21) Appl. No.: 13/533,156

(22) Filed: Jun. 26, 2012

(51) Int. Cl. G06F 3/048

(52) U.S. Cl. 715/773; 715/764

(57) ABSTRACT

Method, computer program product, and system for performing an operation to facilitate selection of user interface (UI) elements on an interactive display, the operation including providing at least a first UI element on the interactive display, defining an input area which, when selected, activates the first UI element, determining a first likelihood of the first UI element being selected, and modifying the input area of the first UI element, based on the first likelihood.

### BACKGROUND

Embodiments disclosed herein relate to the field of computer software. More specifically, embodiments disclosed herein relate to dynamically varying the size of key press zones on an interactive display.

### SUMMARY

Embodiments disclosed herein provide a method, computer program product, and system for performing an operation to facilitate selection of user interface (UI) elements on an interactive display, the operation including providing at least a first UI element on the interactive display, defining an input area which, when selected, activates the first UI element, determining a first likelihood of the first UI element being selected, and modifying the input area of the first UI element, based on the first likelihood.

### BRIEF DESCRIPTION OF THE DRAWINGS

So that the manner in which the above recited aspects are attained and can be understood in detail, a more particular description of embodiments of the disclosure, briefly summarized above, may be had by reference to the appended drawings.

It is to be noted, however, that the appended drawings illustrate only typical embodiments of this disclosure and are therefore not to be considered limiting of its scope, for the disclosure may admit to other equally effective embodiments.

FIG. 1 is a block diagram illustrating targeted key press zones, according to one embodiment disclosed herein.

FIG. 2 is a block diagram illustrating a system for targeted key press zones, according to one embodiment disclosed herein.

FIG. 3 is a flow chart illustrating a method for targeted key press zones, according to one embodiment disclosed herein.

FIG. 4 is a flow chart illustrating a method for adjusting input area settings, according to one embodiment disclosed herein.

FIG. 5 is a flow chart illustrating a method for targeted key press zones using target zones, according to one embodiment disclosed herein.

### DETAILED DESCRIPTION

Embodiments disclosed herein provide a method, computer program product, and system for performing an operation to facilitate selection of user interface (UI) elements on an interactive display, the operation including providing at least a first UI element on the interactive display, defining an input area which, when selected, activates the first UI element, determining a first likelihood of the first UI element being selected, and modifying the input area of the first UI element, based on the first likelihood.

An item, such as a virtual keyboard, displayed on a touch sensitive interactive display, may have a visible object representing a key and an “invisible” boundary representing the input area (also referred to as a “key press zone”) in which a key press is registered, whether or not the keys touch on the screen. The keys may share a common boundary, leaving the virtual keyboard to make a decision as to which key was pressed when a key press is received at or near the input area boundary. In some cases, the visible object boundaries and input area boundaries may be the same. The same concepts may apply to other selectable UI elements on a virtual display, such as phone dialer keys and input buttons. Embodiments disclosed herein may vary the size of the input area to resolve an ambiguous key press based on the expected likelihood of a key press relative to its neighboring keys. The boundaries forming the input area for the accepted key press may expand or contract based on the aforementioned likelihood. Additionally, the input area boundaries may contract inside the visible object space, leaving the edges unable to initiate a key press event. This may leave the displayed keyboard unaltered, retaining maximum usability and readability.

The display which displays the selectable UI elements can be any variety of interactive display technologies that allow users to interact with the display using an electronic pen, a stylus, a finger or other input element/device. By way of example, the underlying mechanism for interacting with the display can be electromagnetic, capacitive, resistive, etc. For purposes of illustration, embodiments will be described herein with respect to a touch sensitive display whereby a user may interact with the display via capacitive coupling (in which the user forms one electrode in a circuit) or via a resistive system in which the pressure applied to the screen by the user's finger urges the screen into contact with an underlying conducting plate thereby registering the contact of the finger at a particular location on the display. But, in any case, the particular underlying interactive display technology is not limiting of the disclosure.

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

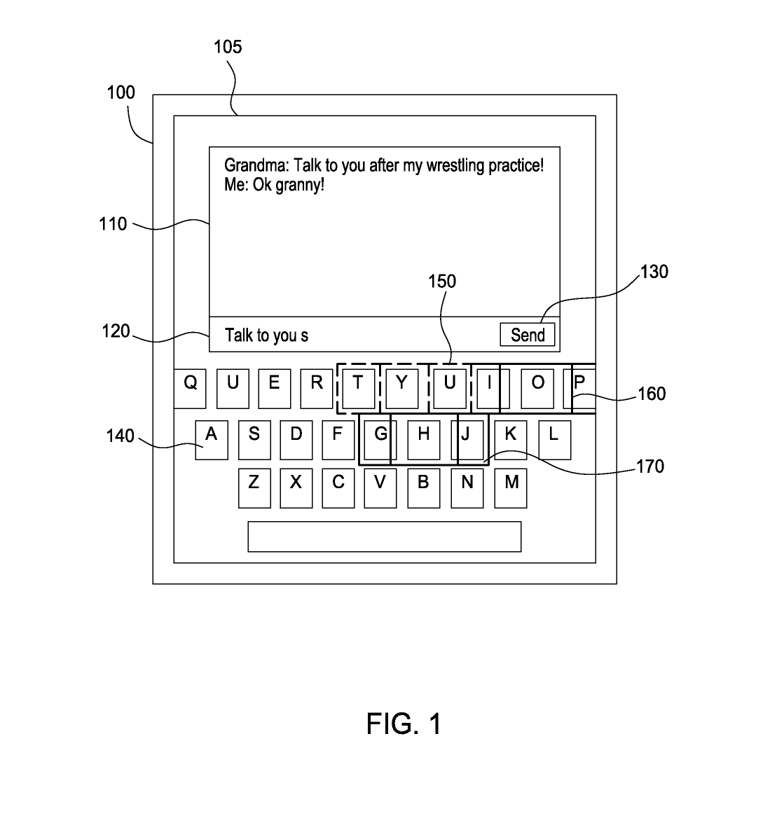

FIG. 1 is a block diagram illustrating targeted key press zones, according to one embodiment disclosed herein. As shown, FIG. 1 includes a device 100 containing a touch screen display 105. The touch screen display 105 is a touch-sensitive display capable of receiving user input when the user touches displayed user interface (UI) elements. Each UI element on the touch screen display 105 is associated with an input area. The input area may be defined by a set of boundaries which may or may not correspond to the visible boundaries of the UI elements produced on the touch screen display 105. When a press is received within the input area, the UI element may be activated or returned as input. As shown, the touch screen display 105 includes a message log 110, an input field 120, a send button 130, and a plurality of virtual keys 140. For example, the message log 110 may be the contents of a text messaging thread or an instant messaging chat log, with messages sent from the input field 120 and messages received from another user being displayed in the message log 110.

As shown, the virtual keys corresponding to the letters “T,” “Y,” and “U” are each enclosed by a dotted line, representing an input area 150. In some embodiments, the input areas 150 correspond to the set of input area boundaries representing the area that a key press is accepted for a given UI element. Input areas 150 may be defined for each UI element on the touch screen display 105, but are omitted from FIG. 1 for clarity and simplicity. For example, the input field 120, the send button 130, and each of the virtual keys 140 may each have its own input area 150. In the input field 120, a message is being typed by a user which reads “Talk to you s”—but has not been completed. In anticipation of the next key stroke, the input areas 150 of some keys may be expanded to adjusted input areas 160 and 170. As shown, the adjusted input areas 160 have increased the input area boundaries for the letter “O” while decreasing the input area boundaries for the letters “I” and “P.” The adjusted input areas 170 have accordingly increased the input area boundaries for the letter “H” while decreasing the input area boundaries for the letters “I” and “P.” The determination to increase the boundaries (and input areas) for the letters “O” and “H” may be made upon determining that those letters were most likely to be pressed by the user, given that the context of the sentence and the fact that the letters “O” and “H” may come next. For example, given the current input, the user may intend to type “Talk to you shortly” or “Talk to you soon.” As the user presses the areas surrounding the letters “O” and “H,” the adjusted input areas 160 and 170 provide additional space for the user to make the correct selection, thereby reducing the number of typos, deletions, and corrections required to complete the user's intended message. Although the adjusted input areas 160 and 170 have been expanded horizontally, they may also be expanded vertically to capture more space on the touch screen display 105. Furthermore, the adjusted input areas 160 and 170 may expand or contract along one, two, three, or all four edges.

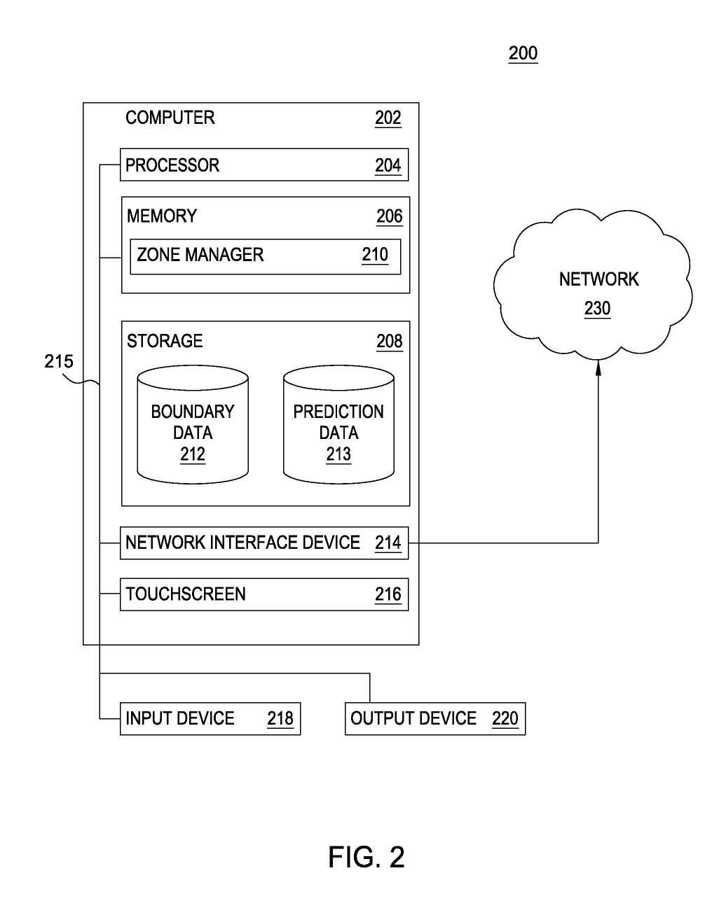

FIG. 2 is a block diagram illustrating a system 200 for targeted key press zones, according to one embodiment disclosed herein. As shown, the system 200 includes a computer 202. The computer 202 may be any computing device which has a touch screen display, including, but not limited to phones, tablets, laptops, computer monitors, personal digital assistants, and the like. The computer 202 generally includes a processor 204 connected via a bus 215 to a memory 206, a network interface device 214, a storage 208, a touchscreen 216, an input device 218, and an output device 220. The computer 202 is connected to a network 230 via the network interface device 214, and may be connected to other computers via the network 230. In general, the network 230 may be a telecommunications network, a local area network (LAN), and/or a wide area network (WAN). In a particular embodiment, the network 230 is the Internet.

The processor 204 is included to be representative of a single CPU, multiple CPUs, a single CPU having multiple processing cores, and the like. Similarly, the memory 206 may be a random access memory. While the memory 206 is shown as a single identity, it should be understood that the memory 206 may comprise a plurality of modules, and that the memory 206 may exist at multiple levels, from high speed registers and caches to lower speed but larger DRAM chips. The network interface device 214 may be any type of network communications device allowing the computer 202 to communicate with other computers via the network 230.

The storage 208 may be a persistent storage device. Although the storage 208 is shown as a single unit, the storage 208 may be a combination of fixed and/or removable storage devices, such as fixed disc drives, solid state drives, floppy disc drives, tape drives, removable memory cards or optical storage. The memory 206 and the storage 208 may be part of one virtual address space spanning multiple primary and secondary storage devices.

The input device 218 may be any device for providing input to the computer 202. For example, a keyboard and/or a mouse may be used. The output device 220 may be any device for providing output to a user of the computer 202. For example, the output device 220 may be any conventional display screen or set of speakers. Although shown separately from the input device 218, the output device 220 and input device 218 may be combined. In some embodiments, some functionality of the input device 218 and the output device 220 may be combined into the touchscreen 216. The touchscreen 216 is an electronic visual display that can detect the presence and location of a touch within the display area. Therefore, the touchscreen 216 can display UI elements to the user and directly receive user input when the user touches the touchscreen 216 with a finger or the like. For example, a virtual keyboard may be displayed to the user. When the user touches a point on the touchscreen 216 corresponding to a key on the keyboard, the key is returned as user input. However, when a user presses a point on a boundary which is shared by two or more keys, the incorrect key may be returned as input.

As shown, the memory 206 contains the zone manager 210. The zone manager 210 is an application generally configured to define, manage, and dynamically modify input area boundaries corresponding to input areas of virtual UI elements displayed on the touchscreen 206. In some embodiments, the zone manager 210 stores and retrieves boundary data from the boundary data 212, shown in the storage 208. For example, when a keyboard is displayed on the touchscreen 216, the zone manager 210 may reference the boundary data 212 to determine the input area boundaries which define the input areas on the touchscreen 216 corresponding to each key of the keyboard. Additionally, the zone manager 210 may modify the input area boundaries to provide expanded (or contracted) input area boundaries for each of the keys on the keyboard, and store the modified boundaries in the boundary data 212. The zone manager 210 may also store delta information on how to modify the boundaries in the boundary data 212. In some embodiments, instead of retrieving default boundaries, the zone manager 210 may use the visible boundaries representing the virtual UI elements as the default boundaries, relieving the need to store and access boundary data. The boundary data 212 is a data store configured to store data regarding boundary information for a plurality of selectable UI elements that may be displayed on the touchscreen 216. In other embodiments, the zone manager 210 may store a value corresponding to the area of a key (or other selectable UI element) and one or more coordinate positions on the touchscreen 216. Any number of methods may be used to link the UI element area, boundaries, and positioning on the touchscreen 216, and the techniques described herein should not be considered limiting of the disclosure.

As shown, the storage 208 also contains prediction data 213. The prediction data 213 is a repository used to store data from which the zone manager 210 may compute the likelihood that a selectable UI element on the touchscreen 216 will be selected as the next input by the user. In some embodiments, the prediction data 213 may contain words, spelling recommendations, frequency data, historical key usage patterns, and other smart type technologies in order to calculate the respective likelihoods of each element. Although depicted as a database, the boundary data 212 and prediction data 213 may take any form suitable for storing data. Although the zone manager 210, boundary data 212, and prediction data 213 are depicted as residing on the same computer, they each may reside on different computers. For example, the zone manager 210 may run on the computer 202, and access the boundary data 212 and prediction data 213 stored on a remote computer through the network interface device 214.

The computer 102 is generally under the control of an operating system (not shown). Examples of operating systems include UNIX, versions of the Microsoft Windows operating system, and distributions of the Linux operating system. (UNIX is a registered trademark of The Open Group in the United States and other countries. Linux is a registered trademark of Linus Torvalds in the United States, other countries, or both. Microsoft and Windows are trademarks of Microsoft Corporation in the United States, other countries, or both.) More generally, any operating system supporting the functions disclosed herein may be used.

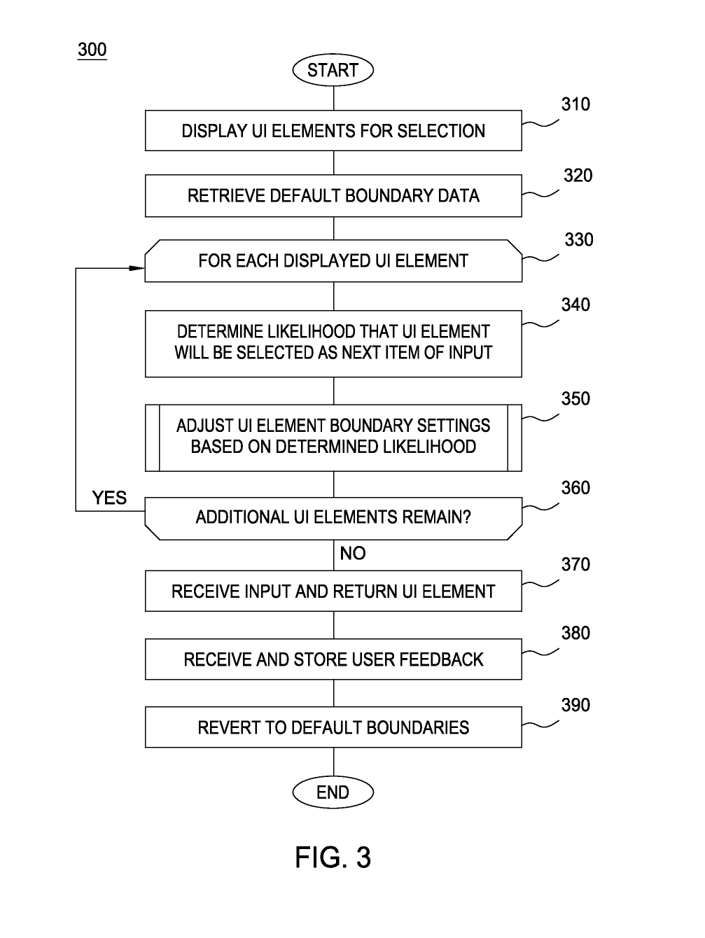

FIG. 3 is a flow chart illustrating a method 300 for targeted key press zones, according to one embodiment disclosed herein. In some embodiments, the zone manager 210 may execute the steps of the method 300. At step 310, the touchscreen 216 displays a screen containing a plurality of selectable UI elements. The selectable UI elements may include, but are not limited to, keyboard keys, phone dialer buttons, input buttons, any element configured to be selected as input, and any element configured to be activated upon selection (for example, activating a text box for typing text input). At step 320, the zone manager 210 may retrieve default boundary data for the plurality of selectable UI elements for display on the touchscreen 216. In some embodiments, the zone manager 210 retrieves the default boundary data from the boundary data 212. The zone manager 210 may retrieve the boundary data for all selectable UI elements available on the display of the touchscreen 216. For example, if a keyboard is displayed on the touchscreen 216, the default boundary data for each key may be retrieved by the zone manager 210. In some embodiments, default boundary data for less than all of the UI elements may be retrieved by the zone manager 210.

At step 330, the zone manager 210 executes a loop containing steps 340-360 for each UI element displayed for selection via touchscreen input. At step 340, the zone manager 210 determines the likelihood that the current UI element will be selected as the next UI element of input. In some embodiments, the zone manager 210 accesses the prediction data 213 to make this determination. As stated above, the prediction data 213 may include spelling recommendations, historical key usage patterns, frequency data, historical key usage patterns, and other smart type technologies used to calculate the likelihood that a UI element will be selected as the next UI element of input. For example, if the user is typing a text message and has entered “New York Gi”, the zone manager 210 may access the prediction data 213 to determine which letters are most likely to follow the “i” in “New York Gi.” Based on the information contained in the prediction data 213, the zone manager 210 may determine that an “a” (as in “Giants”) and an “f” (as in “Gifts”) are the most likely letters to follow the “i.” For example, “Giants” and “Gifts” may be the most likely words found in the prediction data 213. The zone manager 210 may also determine that an “a” and an “f” are the most likely letters to follow “Gi” based on frequency data in the prediction data 213. In another example, if a user has pressed a key to exit a document editor but has not saved changes, the zone manager 210 may access predefined data in the prediction data 213 which may make the displayed “Yes” response more likely to be selected than a displayed “No” response when the user is asked whether they would like to save their document before exiting. In some embodiments, the zone manager 210 may compute a likelihood score for each UI element analyzed at step 340 corresponding to the likelihood that the UI element will be selected as the next UI element of input. For example, if a “Q” has been entered, the zone manager 210 may assign a score to the letter “U” indicating that “U” is the letter having highest likelihood of being selected next. Any suitable scoring method may be implemented by the zone manager 210.

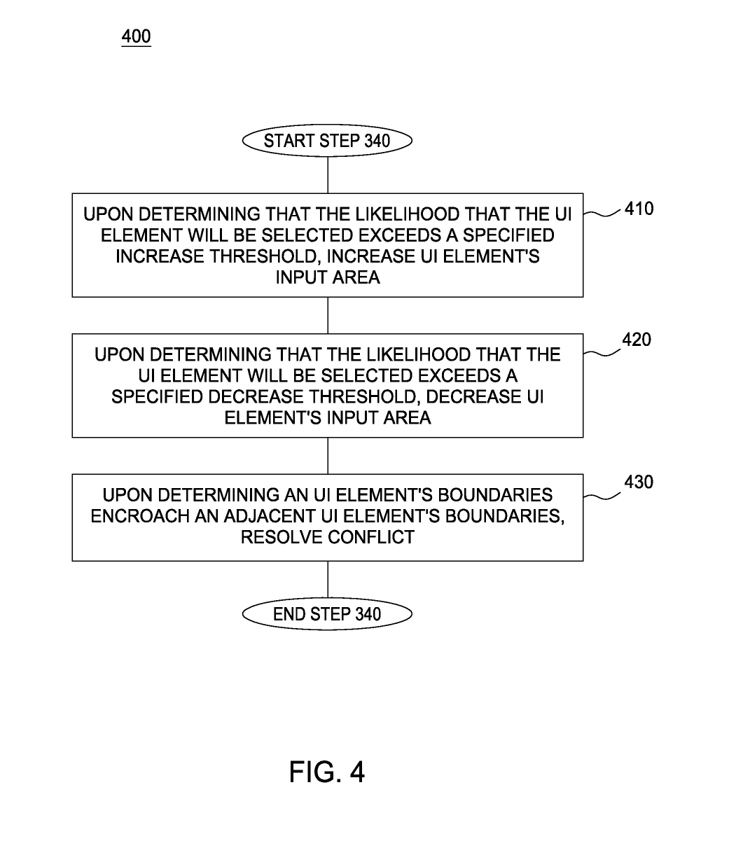

At step 350, discussed in further detail with reference to FIG. 4, the zone manager 210 adjusts the UI element's input area settings based on the determined likelihood. In some embodiments, the step 350 may comprise adjusting one or more of the boundaries defining the input area. In some embodiments, the zone manager 210 may not adjust the input area if the likelihood does not exceed a predefined threshold. In some embodiments, the zone manager 210 adjusts the different sides of the input area to different degrees in order to take into account the likelihood that nearby UI elements will be adjusted as well. For example, the UI elements may be compared to their neighboring UI elements, and the boundaries of each may be adjusted proportionally according to their likelihoods. In some embodiments not utilizing thresholds, the boundaries may be adjusted based on the likelihoods of the UI element being selected, however slight. Generally, any suitable method for adjusting the boundaries may be implemented. At step 360, the zone manager 210 determines whether additional UI elements remain. If additional UI elements need to be examined, the zone manager 210 returns to step 330. Otherwise, all selectable UI elements have been analyzed, and the zone manager 210 proceeds to step 370. At step 370, the zone manager 210 receives user input selecting a UI element on the touchscreen 216 and returns that UI element as input. In some embodiments, at step 380, a user may provide feedback to the zone manager 210. For example, a feedback mechanism may be provided to allow the user to indicate a correct or incorrect UI element returned at step 370. Upon receiving feedback, the zone manager 210 may make corresponding changes in the prediction data 213. In some embodiments, the zone manager 210 may monitor detailed information regarding the situational context leading up to the UI element returned at step 370, and update the historical data associated with the UI element in the prediction data 213. In some embodiments, the zone manager 210 may take implicit feedback. For example, if the user deletes the UI element returned at step 370, the zone manager may imply negative feedback, and make a corresponding negative change to the prediction data 213, for example, decrementing the frequency data associated with the UI element. If the user does not delete the UI element returned at step 370, the zone manager 210 may make a corresponding positive change to the prediction data 213, for example, incrementing the frequency data associated with the UI element. At step 390, the zone manager 210 may revert to the default zone settings to reset the boundaries of each selectable UI element. Having received user input, the method 300 may end. Alternatively, the zone manager 210 may repeat the steps of the method 300 at any time the touchscreen 216 presents UI elements for user selection.

FIG. 4 is a flow chart illustrating a method 400 corresponding to step 430 for adjusting input area settings, according to one embodiment disclosed herein. In some embodiments, the zone manager 210 performs the steps of the method 400. At step 410, the zone manager 210 increases the UI element's input area upon determining that the UI element's likelihood score exceeds a specified increase threshold. The increase may be a constant increase, or may be proportional to the likelihood score. For example, if a text input field has “Q” as the only current letter, a “U” may have a likelihood score of 95 (on a scale of 100), which falls above an exemplary increase threshold of 60. The input area (or its boundaries) of “U” may therefore be expanded in an appropriate manner to reflect the very high likelihood that a “U” may be entered next. At step 420, the zone manager 210 decreases the UI element's input area upon determining that the UI element's likelihood score exceeds a specified decrease threshold. The decrease may be a constant decrease, or may be proportional to the likelihood score. For example, if a text input field has “Q” as the only current letter, a “Z” may have a likelihood score of 5 (on a scale of 100), which falls below an exemplary decrease threshold of 20. The input area of “Z” may therefore be contracted in an appropriate manner to reflect the very low likelihood that a “Z” may be entered next. At step 430, the zone manager 210 resolves conflicts upon determining that a UI element's input area boundaries encroach the input area boundaries of an adjacent UI element. The zone manager 210 may take any suitable approach to resolving the conflicts, including prioritizing UI elements based on likelihood scores, splitting conflict zones in half, splitting conflict zones by a ratio of likelihood scores, a proportional splitting, and the like. If the likelihood scores are very similar, the boundaries may be adjusted to give each UI element an input area which is roughly equal. Additionally, the zone manager 210 may, upon executing the steps of the method 400, determine that no boundaries are to be expanded or contracted, leaving the default boundaries intact.

In one embodiment, UI elements may be weighed only against their neighbors. In the “New York Gi” example, “a” would have a much higher likelihood than “s” “q” or “z” to be next and the boundary for “a” could expand significantly in all 3 directions. The input area for “a” may also have a lower likelihood of being next than “t” but, because of its adjacencies, “a” would have a larger modified input area than “t”. The degree to which one expands/contracts relative to the neighbor could be a ratio of the values or a magnitude of the difference.

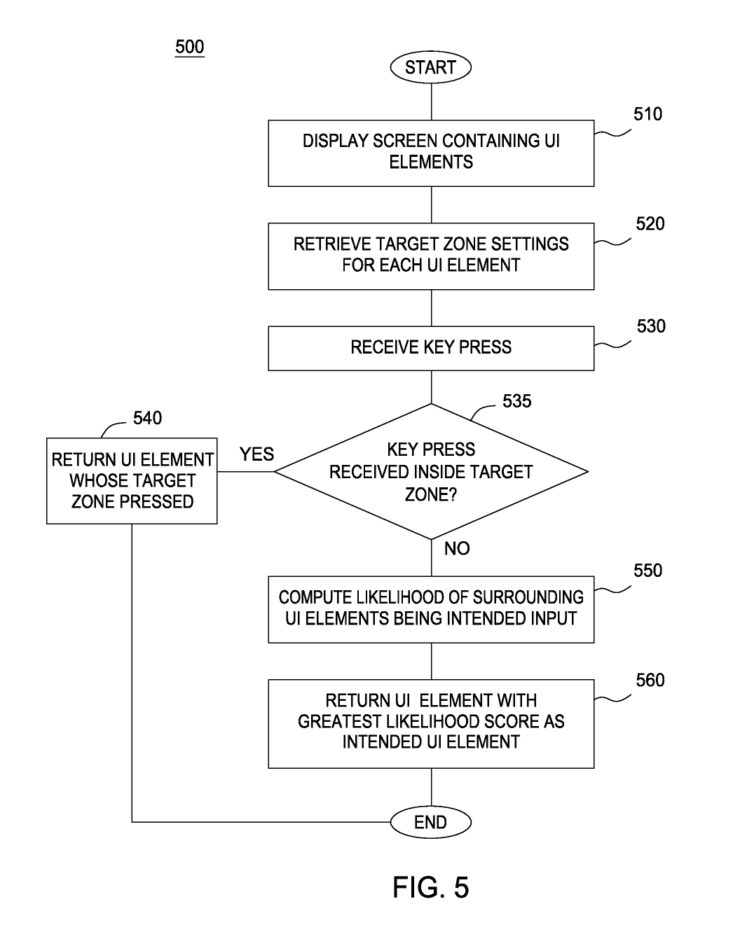

FIG. 5 is a flow chart illustrating a method 500 for targeted key press zones using target zones, according to one embodiment disclosed herein. In some embodiments, selectable UI elements may be assigned a “target zone,” which corresponds to an input area that, if pressed, always returns the selectable UI element corresponding to the target zone. A target zone may not be encroached by an adjusted boundary from an adjacent UI element. A target zone may be defined by boundaries which may be stored in the boundary data 212. Additionally, a target zone may also be defined by a fixed value from the center of a UI element or by a ratio from the center based on the size of the UI element. In some embodiments, the target zone data is stored in the zone data 212. In some embodiments, the zone manager 210 performs the steps of the method 500. At step 510, the touchscreen 216 displays a screen containing a plurality of selectable UI elements. The selectable UI elements may include, but are not limited to, keyboard keys, phone dialer buttons, input buttons, any UI element configured to be selected as input, and any UI element configured to be activated upon selection (for example, activating a text box for typing text input). At step 520, the zone manager 210 may retrieve target zone data for the plurality of selectable UI elements for display on the touchscreen 216. In some embodiments, the zone manager 210 retrieves the target zone data from the boundary data 212. The zone manager 210 may retrieve the target zone data for all selectable UI elements available on the display of the touchscreen 216. For example, if a keyboard is displayed on the touchscreen 216, the boundary data for each key may be retrieved by the zone manager 210. In some embodiments, target zone data for less than all of the UI elements may be retrieved by the zone manager 210.

At step 535, the zone manager 210 receives a key press from a user. At step 535, the zone manager 210 determines whether the key press was received inside a target zone of one of the UI elements displayed on the touchscreen 216. If the key press was received inside a target zone, the zone manager 210 proceeds to step 540, where the UI element whose target zone was pressed is returned as the user's selection, and the method 500 ends. If the key press was not received inside a target zone, the zone manager 210 proceeds to step 550. At step 550, the zone manager 210 computes the likelihood of each of the surrounding items being the intended item of selection by the user. For example, if the key press was received between the target zones of the letters “T,” “F,” and “G,” the zone manager 210 may compute the likelihood of each of these letters being the intended input. In some embodiments, the zone manager 210 performs the same analysis techniques as described above with reference to step 340. In some embodiments, the zone manager 210 computes a likelihood score for each surrounding UI element. At step 560, the zone manager 210 returns the surrounding UI element with the greatest likelihood score as the intended UI element. In some embodiments, the UI element with the greatest likelihood score may not be returned as the intended UI element. For example, the likelihoods of each UI element may be weighed against each other, UI element boundaries may be modified, and the UI element having the modified boundary in which the key press fell inside of is returned. In other words, if the target zone was just missed for the UI element with the lowest likelihood, it may still very likely be returned as the selected UI element. As described above with reference to FIG. 3, user feedback may be received upon returning the UI element in order to improve accuracy and decrease the number of incorrect predictions made by the zone manager 210.

In addition, embodiments disclosed herein provide a user with the option of defining target and default input areas for any selectable UI element displayed on his or her touchscreen device. A graphic user interface may be presented to the user to receive boundaries for each selectable UI element, for example, keys on a keyboard. Upon receiving the user input, the boundary data may be saved to the boundary data 212, providing a completely customizable touchscreen experience for a plurality of users.

By dynamically expanding and contracting input area key press boundaries as disclosed herein, improving the accuracy of touches on a touchscreen may be achieved in a non-intrusive manner. Embodiments disclosed herein do not alter the screen, keys, and display. In many instances, no words are corrected and replaced after the fact, as the accuracy of a single key press is increased by embodiments disclosed herein. In addition, no user calibration step is required to utilize the functionality of the embodiments disclosed herein.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

1.-7. (canceled)

8. A computer program product to facilitate selection of user interface (UI) elements on an interactive display, the computer program product comprising:
a computer-readable storage medium having computer-readable program code embodied therewith, the computer-readable program code comprising:
computer-readable program code configured to provide at least a first UI element on the interactive display;
computer-readable program code configured to define an input area which, when selected, activates the first UI element;
computer-readable program code configured to determine a first likelihood of the first UI element being selected; and
computer-readable program code configured to modify the input area of the first UI element, based on the first likelihood.

9. The computer program product of claim 8, wherein the first UI element on the interactive display is not modified, the method further comprising:
prior to modifying the input area of the first UI element, receiving a selection falling outside of the input area.

10. The computer program product of claim 8, further comprising:
receiving a selection at a point on the interactive display;
upon determining that the point is within the modified input area of the first UI element, registering the first UI element as input;
determining, for at least a second UI element and based on the first UI element registered as input, a second likelihood of the second UI element being selected; and
modifying the input area of the second UI element, based on the second likelihood, wherein the second UI element on the interactive display is not modified.

11. The computer program product of claim 8, wherein the first UI element comprises a key of a virtual keyboard.

12. The computer program product of claim 8, wherein the first likelihood is based on historical usage patterns.

13. The computer program product of claim 13, further comprising:
upon receiving a selection of the modified first UI element, modifying the historical usage patterns to reflect the selection of the modified first UI element.

14. The computer program product of claim 8, wherein modifying the input area comprises at least one of: (i) increasing, and (ii) decreasing the input area.

15. A system, comprising:
one or more computer processors;
a memory containing a program, which, when executed by the one or more computer processors, performs an operation to facilitate selection of user interface (UI) elements on an interactive display, comprising:
providing at least a first UI element on the interactive display;
defining an input area which, when selected, activates the first UI element;
determining a first likelihood of the first UI element being selected; and
modifying the input area of the first UI element, based on the first likelihood.

16. The system of claim 15, wherein the first UI element on the interactive display is not modified, the method further comprising:
prior to modifying the input area of the first UI element, receiving a selection falling outside of the input area.

17. The system of claim 15, further comprising:
receiving a selection at a point on the interactive display;
upon determining that the point is within the modified input area of the first UI element, registering the first UI element as input;
determining, for at least a second UI element and based on the first UI element registered as input, a second likelihood of the second UI element being selected; and
modifying the input area of the second UI element, based on the second likelihood, wherein the second UI element on the interactive display is not modified.

18. The system of claim 15, wherein the first UI element comprises a key of a virtual keyboard.

19. The system of claim 15, wherein modifying the input area comprises at least one of: (i) increasing, and (ii) decreasing the input area, wherein the first likelihood is based on historical usage patterns.

20. The system of claim 19, wherein modifying the input area comprises at least one of: (i) increasing, and (ii) decreasing the input area.
